(19) United States
(12) Patent Application Publication
(10) Pub. No.: US 2015/0376449 A1
(43) Pub. Date: Dec. 31, 2015

(54) BARRIER FILM, METHODS OF MANUFACTURE THEREOF AND ARTICLES COMPRISING THE SAME

(71) Applicant: DOW GLOBAL TECHNOLOGIES LLC, Midland, MI (US)

(72) Inventors: Douglas E. Beyer, Midland, MI (US); Steven R. Jenkins, Traverse City, MI (US); Mark W. VanSumeren, Midland, MI (US); Jin Wang, Midland, MI (US)

(21) Appl. No.: 14/316,872

(22) Filed: Jun. 27, 2014

(51) Int. Cl. C09D 179/02; C09D 133/02

(52) U.S. Cl. CPC C09D 179/02; C09D 133/02

(57) ABSTRACT

Disclosed herein is a barrier film comprising a substrate comprising a first surface and a second surface; where the first surface and the second surface are opposedly disposed to each other; and a barrier coating comprising alternating layers of cationic material and anionic material; where the barrier coating is reactively bonded with at least the first surface of the substrate. Disclosed herein too is a method comprising disposing upon a substrate a barrier coating comprising alternating layers of cationic material and anionic material; where the barrier coating is reactively bonded with at least one surface of the substrate.

### BACKGROUND

This disclosure relates to a barrier film, methods of manufacture thereof and to articles comprising the same.

Barrier films are useful for minimizing the transmission of oxygen and water vapor through the film to products that are contained in packaging made from the barrier film. Fruit and produce containers are often filled for transport and later stacked on site for display and/or storage purposes. As such, there are a variety of container configurations which facilitate the ability to stack multiple containers. Corrugated paperboard has been used for many years as a starting material to produce containers. Containers of corrugated paperboard include a single piece tray design having a bottom wall, two side walls, and two end walls, each hinged to the bottom wall. A single piece of corrugated paperboard will be cut and scored to form a flat blank that will then be erected into a container.

However, corrugated containers are prone to damage which occurs during handling, stacking, or impact by equipment or other materials. Further, since many paperboard containers are shipped or stored under refrigerated conditions, ambient moisture absorbed by the container often weakens the container to the point that its utility is compromised.

In addition, retailers prefer to use the shipping container for direct display for consumer sales. Typical corrugated containers used for this purpose often have minimal aesthetic properties. Further, such containers tend to be rapidly soiled by the container's contents, which further reduce the appearance of the packaging and retail display.

There remains a need to provide a container for transporting goods that has increased durability, greater strength, is more economical to store and ship, and is readily recyclable in conventional re-pulping operations. Accordingly, there remains room for improvement and variation within the art.

### SUMMARY

Disclosed herein is a barrier film comprising a substrate comprising a first surface and a second surface; where the first surface and the second surface are opposedly disposed to each other; and a barrier coating comprising alternating layers of cationic material and anionic material; where the barrier coating is reactively bonded with at least the first surface of the substrate.

Disclosed herein too is a method comprising disposing upon a substrate a barrier coating comprising alternating layers of cationic material and anionic material; where the barrier coating is reactively bonded with at least one surface of the substrate.

### DETAILED DESCRIPTION

“Blend”, “polymer blend” and like terms mean a composition of two or more polymers. Such a blend may or may not be miscible. Such a blend may or may not be phase separated. Such a blend may or may not contain one or more domain configurations, as determined from transmission electron spectroscopy, light scattering, x-ray scattering, and any other method known in the art. Blends are not laminates, but one or more layers of a laminate may contain a blend.

“Polymer” means a compound prepared by polymerizing monomers, whether of the same or a different type. The generic term polymer thus embraces the term homopolymer, usually employed to refer to polymers prepared from only one type of monomer, and the term interpolymer as defined below. It also embraces all forms of interpolymers, e.g., random, block, etc. The terms “ethylene/a-olefin polymer” and “propylene/a-olefin polymer” are indicative of interpolymers as described below. It is noted that although a polymer is often referred to as being “made of” monomers, “based on” a specified monomer or monomer type, “containing” a specified monomer content, or the like, this is obviously understood to be referring to the polymerized remnant of the specified monomer and not to the unpolymerized species.

“Interpolymer” means a polymer prepared by the polymerization of at least two different monomers. This generic term includes copolymers, usually employed to refer to polymers prepared from two or more different monomers, and includes polymers prepared from more than two different monomers, e.g., terpolymers, tetrapolymers, etc.

“Polyolefin”, “polyolefin polymer”, “polyolefin resin” and like terms mean a polymer produced from a simple olefin (also called an alkene with the general formula CₙH₂ₙ) as a monomer. Polyethylene is produced by polymerizing ethylene with or without one or more comonomers, polypropylene by polymerizing propylene with or without one or more comonomers.

The term and/or is used herein to mean both “and” as well as “or”. For example, “A and/or B” is construed to mean A, B or A and B.

The transition term “comprising” is inclusive of the transition terms “consisting essentially of” and “consisting of” and can be interchanged for “comprising”.

Disclosed herein is a film (hereinafter film or barrier layer film) comprising a barrier layer that comprises a polymeric substrate upon which is disposed a plurality of opposedly charged ionic layers (also sometimes called a “barrier coating”). In one embodiment, the polymeric substrate comprises a reactive functionality that can undergo covalent or ionic bonding with at least one of the opposedly charged ionic layers. In another embodiment, the substrate can be neutral and is coated with a first interfacial layer before having the opposedly charged ionic layers disposed on the substrate. In an embodiment, the opposedly charged ionic layers are disposed on only a single surface of the substrate using a layer-by-layer deposition technique. In another embodiment, the opposedly charged ionic layers are disposed on all opposing surfaces of the substrate using a layer-by-layer deposition technique. In another embodiment the substrate can be neutral and is treated to created surface charges or functionality.

The substrate generally has a reactive surface obtained by coextruding a reactive polymer on surface of a non-reactive polymer (a neutral polymer), laminating a reactive polymer on the surface of the non-reactive polymer or coating a reactive polymer on the surface of a non-reactive polymer. The reactive polymer surface on which the opposedly charged ionic layers are disposed may be derived from grafting a reactive monomer on to the surface of the non-reactive polymer. Any of these means result in a “substrate” that is reactive (covalent or ionic bonded) towards the first LBL coating layer.

It is desirable for the substrate to be wetted by the first charged ionic layer that is deposited from solution via a layer-by-layer technique. In other words, the ionic solution will form a continuous film on the surface of the substrate when dipped, sprayed or otherwise exposed to the substrate surface. It is also desirable for the substrate to be a sufficiently adhesive surface to provide sufficient adhesion to the first ionic layer of the opposedly charged ionic layers to meet the needs of the application.

The substrate material is in the form of a film or sheet. As discussed in detail below, the substrate can be neutral or reactive. Neutral substrates can have layer(s) disposed thereon that provide reactivity to the first ionic layer of the opposedly charged ionic layers that are disposed using the layer-by-layer technique. The reactive substrate polymer may be either a monolayer film or the skin layer in a multilayer film (or sheet) and may be either symmetric or asymmetric. An asymmetric film or sheet is one in which the layers on one side of the longitudinal axis are different (either dimensionally, compositionally or in quantity) from those on the other side of the longitudinal axis. A symmetric film is one where the layers on one side of the longitudinal axis are the same (either dimensionally, compositionally or in quantity) as those on the other side of the longitudinal axis.

Multilayer substrates may comprise two or more layers, where each coated surface includes the reactive polymer. The reactive substrate polymer may be blended with other polymers or copolymers. Multilayer films may be produced by coextrusion, lamination or coating. In one embodiment, the substrate can have a reactive surface that is produced by grafting a reactive species onto the molecules of the substrate. In another embodiment, the substrate can have a reactive surface that is produced by irradiating the substrate surface with xrays, electrons, ions, UV radiation, visible radiation, corona treatment, flame ionization treatment, ozonlysis, sulfonation, or the like, or combinations thereof.

The substrate onto which the barrier coating is deposited can therefore be any substrate that has an inherently reactive surface or that contains a reactive coating disposed thereon. The reactive surface or the reactive coating can be one that can react covalently or ionically with the opposedly charged ionic layers disposed on the substrate. In one embodiment, the reactive coating can include a cationic organic material or an anionic organic material that can be adsorbed directly or indirectly onto with the aid of an adhesion promoter or tie layer. The substrate may be rigid or may be flexible.

The substrate may either be neutral or can be reactive (i.e. it contains either anionic or cationic species and can react with an ionic layer disposed on it). When the substrate is neutral, it is desirable to coat the substrate with a “first interfacial layer” prior to coating it in a layer-by-layer process with the opposedly charged ionic layers. The first interfacial layer may be cationic or anionic and is capable of being bonded to the neutral substrate or being absorbed into the neutral substrate.

In an alternative embodiment, the substrate is not neutral and is reactive (i.e., it is either anionic or cationic). In one embodiment, when the first layer disposed on the substrate is cationic, it is desirable for the substrate to be anionic, and alternatively, when the first layer is anionic, it is desirable for the substrate to be cationic.

In one embodiment, the substrate can be neutral i.e., it does not contain any charged species (e.g. acidic, basic or ionic species). The substrate comprises a low surface energy polymer and preferably comprises a polyolefin, a polymer derived from a vinyl aromatic monomer, or combinations thereof. The substrate can comprise a homopolymer, a copolymer such as a star block copolymer, a graft copolymer, an alternating block copolymer or a random copolymer, an ionomer, a dendrimer, or a combination comprising at least one of the foregoing types of low surface energy polymers. The copolymer can comprise segments that are acidic, basic or ionic (e.g., neutralized acidic or basic segments).

When the substrate is neutral it comprises a polyolefin, a polymer derived from a vinyl aromatic monomer, or combinations thereof without any acidic, basic or ionic species. Examples of neutral polymeric substrates are ultralow density polyethylene (ULDPE), low density polyethylene (LDPE), linear low density polyethylene (LLDPE), medium density polyethylene (MDPE), high density polyethylene (HDPE), high melt strength high density polyethylene (HMS-HDPE), ultrahigh density polyethylene (UHDPE), polypropylene (PP), polystyrene, ethylene vinyl acetate, ethylene methyl acrylate, ethylene butyl acrylate, or the like, or combinations thereof.

In one embodiment, the substrate comprises at least one functional group that is capable of reacting with at least the ionic layer that contacts it. The substrate may comprise a carboxylated olefin copolymer. The carboxylated olefin copolymer comprises an ethylene or propylene polymer that has grafted thereto an unsaturated carboxylic acid or an anhydride, ester, amide, imide or metal salt thereof, hereafter designated as “grafting compound”. The grafting compound preferably is an aliphatic unsaturated dicarboxylic acid or an anhydride, an ester, amide, imide or metal salt derived from such acid. The carboxylic acid preferably contains up to 6, more preferably up to 5 carbon atoms.

The acid or basic species in the substrate can be neutralized with a metal salt. Cations used in the neutralization by metal salts are Li⁺, Na⁺, K⁺, Zn²⁺, Ca²⁺, Co²⁺, Ni²⁺, Cu²⁺, Pb²⁺, and Mg²⁺. Alkali metal salts are preferred.

Examples of unsaturated carboxylic acids are maleic acid, fumaric acid, itaconic add, acrylic acid, methacrylic acid, crotonic acid, and citraconic acid. Examples of derivatives of unsaturated carboxylic acids are maleic anhydride, citraconic anhydride, itaconic anhydride, methyl acrylate, methyl methacrylate, ethyl acrylate, ethyl methacrylate, butyl acrylate, butyl methacrylate, glycidyl acrylate, glycidyl methacrylate, or the like, or a combination thereof. Maleic anhydride is the preferred grafting compound. One or more, preferably one, grafting compound is grafted onto the olefin polymer.

The content of the grafted compound in the olefin copolymer is in the range of 0.05, more specifically from 0.5, and most specifically from 2.0, to 30, specifically to 15, and most specifically to 8 weight percent, based on the total weight of the grafted olefin copolymer.

The graft process can be initiated by decomposing initiators to form free radicals, including azo-containing compounds, carboxylic peroxyacids and peroxyesters, alkyl hydroperoxides, and dialkyl and diacyl peroxides, among others. Many of these compounds and their properties have been described (Reference: J. Branderup, E. Immergut, E. Grulke, eds. “Polymer Handbook,” 4th ed., Wiley, New York, 1999, Section II, pp. 1-76.). Alternatively, the grafting compound can be copolymerized with ethylene in tubular and autoclave processes.

The grafted olefin polymer is selected from the list provided above. By the term “olefin polymer” is meant an ethylene polymer, a propylene polymer, a blend of different ethylene polymers, a blend of different propylene polymers or a blend of at least one ethylene polymer and at least one propylene polymer. The olefin polymer preferably has a crystallinity of 5 to 75 weight percent, more preferably of 10 to 30 weight percent.

The olefin polymer can be an ethylene or propylene homopolymer or an interpolymer of propylene and at least one C₄-C₂₀-α-olefin and/or a C₄-C₁₈-diolefin. Preferably, the ethylene polymer is an interpolymer of ethylene and at least one C₃-C₂₀-α-olefin and/or a C₄-C₁₈-diolefin. Most preferably, the ethylene polymer is an interpolymer of ethylene and a C₃-C₂₀-α-olefin having a density of up to 0.902 g/cm³. The term “interpolymer” as used herein refers to polymers prepared by the polymerization of at least two different monomers. The generic term interpolymer thus embraces copolymers, usually employed to refer to polymers prepared from two different monomers, and polymers prepared from more than two different monomers. The interpolymer can be a random or block interpolymer.

Preferred α-olefins contain 4 to 10 carbon atoms, of which 1-butene, 1-hexene, 4-methyl-1-pentene and 1-octene are the most preferred. Preferred diolefins are isoprene, butadiene, 1,4-pentadiene, 1,4-hexadiene, 1,5-hexadiene, 1,7-octadiene, 1,9-decadiene, dicyclopentadiene, methylene-norbornene, and 5-ethylidene-2-norbornene. The interpolymers may contain other comonomers, such as a C₂-C₂₀ acetylenically unsaturated monomer.

Examples of vinyl aromatic monomers from which the polymeric substrate can be obtained are styrene, vinyl toluene, divinylbenzene, 4-hydroxy styrene, 4-acetoxy styrene, 4-methylstyrene, α-methylstyrene, monochlorostyrenes (e.g. o- or p-chlorostyrene or mixtures), alpha-methyl-p-methylstyrene, 2-chloro-4-methylstyrene, tert-butylstyrenes, dichlorostyrenes, 2,4-dichlorostyrene, sulfostyrene, or the like, or a combination comprising at least one of the foregoing vinyl aromatic monomers. As noted above, the substrate may be neutral or may comprise a charged species. The polymeric substrate derived from styrene may also be sulfonated.

Where the first layer of the LBL coating is cationic material such as polyethylenimine, the desired substrate is an anionic copolymer or copolymer capable of reacting with the cationic coating layer. Suitable substrate polymers include anionic polymers such as ethylene-acrylic acid copolymer, maleic anhydride grafted polyethylene, ethylene acrylic acid copolymer neutralized with sodium or zinc salt, polystyrene sulfonic acid or styrene-maleic anhydride copolymer. Preferred copolymers are ethylene acrylic acid copolymer (commercially available as NUCREL® or PRIMACOR®), ethylene-acrylic acid copolymer neutralized with sodium or zinc salt (commercially available as SURLYN® or AMPLIFY IO®) and/or maleic anhydride grafted polyethylene.

Where the first layer of the LBL coating is an anionic material such as polyacrylic acid or montmorillonite, or other ionized inorganic high aspect ratio platelets, the desired substrate is a cationic copolymer or copolymer capable for reacting with the anionic coating layer. Suitable substrate polymers include cationic copolymers such as amine grafted polyethylene detailed in U.S. Pat. No. 8,450,430 B2 to Silvis, which is incorporated in its entirety by reference or poly-4-amino styrene.

When the first layer of the LBL coating is “cationic” preferred substrates are ethylene-acrylic acid copolymer, ethylene-methacrylic acid copolymer, inorganic salts of the ethylene-acrylic acid copolymer, salts of the ethylene-methacrylic acid copolymer, maleic anhydride grafted polyethylene, or the like or a combination comprising at least one of the foregoing substrates. Blends of ethylene-acrylic acid copolymer, ethylene-methacrylic acid copolymer, inorganic salts of the ethylene-acrylic acid copolymer, inorganic salts of the ethylene-methacrylic acid copolymer, maleic anhydride grafted polyethylene, or the like, or a combination comprising at least one of the foregoing substrates with polyolefins are also used as substrates

When the substrate comprises an ethylene-acrylic acid and/or an ethylene-methacrylic acid copolymer, the acrylic acid or methacrylic acid or combinations thereof are present in amounts of 2 to 22 weight percent, preferably 3 to 20.5 weight percent and more preferably 5 to 17 weight percent, based on the total number of weight of the ethylene-acrylic acid and/or an ethylene-methacrylic acid copolymer. The ethylene-acrylic acid and/or an ethylene-methacrylic acid has a melt index of 0.5 to 1300 gm/10 min and preferably a MI of 1 to 8 gm/10 min when measured at 190° C. and a weight/force of 2.16 Kg, as per ASTM D1238.

Where the substrate comprises a polyethylene-acrylic acid copolymer neutralized with a metal salt (i.e. sodium, zinc or magnesium, combinations thereof or combinations with hydrogen), it comprises 2 to 22 weight percent, preferably 3 to 21 weight percent and more preferably 6 to 20 weight percent comonomer units derived from acrylic acid (based on the total weight of the unneutralized polyethylene-acrylic acid copolymer) and having a melt index of 0.5 to 1300 gm/10 min and preferably a melt index of 1 to 8 gm/10 min when measured at 190° C. and a weight/force of 2.16 Kg as per ASTM D1238.

Where the substrate comprises a maleic anhydride grafted polyethylene or a blend of maleic anhydride grafted polyethylene with polyethylene, it comprises 0.05 to 1.5 weight percent, preferably 0.05 to 0.5 weight percent and more preferably 0.1 to 0.3 weight percent maleic anhydride, based on the total number of weight of the maleic anhydride grafted polyethylene. The maleic anhydride grafted polyethylene has a melt index of 0.5 to 8 gm/10 min and preferably 1 to 6.5 gm/10 min when measured at 190° C. and a weight/force of 2.16 Kg as per ASTM D1238.

The substrate can also contain other polymers. Examples of such polymers are nylon and nylon copolymers, polypropylene and propylene copolymers, polystyrene, polycarbonate, polylactic acid, chlrorotrifluoroethylene copolymers, cyclic olefin copolymers, polybutene, polyvinylidene chloride copolymer or ethylene vinyl alcohol copolymer, polyesters, like polyethylene terephthalate, polyglycolic acid, polylactic acid polybutylene succinate, and acrylic polymers such as polymethyl methacrylate, or the like, or a combination comprising at least one of the foregoing polymers. The foregong polymers may be blended with the polymers used in the substrate or may be used as layers in a multilayer substrate. Appropriate tie layers may be used as desired. The substrate has a thickness of 3 to 1000 micrometers, preferably 4 to 750 micrometers and more preferably 5 to 500 micrometers.

As stated above, the substrate is coated with a plurality of opposedly charged ionic layers using layer-by-layer technology to create the barrier layer film. During layer-by-layer deposition, the substrate (usually charged) is dipped back and forth between dilute baths of positively and negatively charged solutions. Dipping is not the only method that can be used. Other methods such as spray coating, spin coating, doctor blading may be used in lieu of dip coating or in combination with dip coating. These will be discussed later.

During each dip, a small amount of the positively or negatively charged solutions is adsorbed and the surface charge is reversed, allowing the gradual and controlled build-up of electrostatically bonded films of polycation-polyanion layers. Layer-by-layer films can also be constructed by substituting charged species such as nanoparticles or clay platelets in place of or in addition to one of the positively and negatively charged solutions. Layer-by-layer deposition may also accomplished using hydrogen bonding instead of covalent or polar bonding. In this process, the substrate is coated with multiple layers of alternating aqueous solutions of cationic and anionic materials. In other words, the opposedly charged ionic layers disposed on the substrate comprise alternating layers of anionic and cationic materials.

The cationic and anionic materials may comprise small molecules (e.g., monomers, dimers, trimers, and the like, up to about 10 repeat units) or polymers (e.g., molecules having more than 10 repeat units). In an exemplary embodiment, the cationic and the anionic materials are polymers.

Cationic polymers may be naturally derived or synthetically derived. They may comprise linear polymers and/or branched polymers. Examples of naturally derived polymers (which are derived from living or once-living matter) include chitosan.

Copolymers that include at least one of the foregoing naturally occurring cationic polymers may be used. Examples of synthetically derived cationic polymers include branched polyethylenimine, linear polyethylenimine, polydiallyldimethyl ammonium chloride, polyallylamine hydrochloride, poly-L-lysine, poly(amidoamines), poly(amino-co-esters), poly(2-N,N-dimethylaminoethylmethacrylate), poly(ethylene glycol-co-2-N,N-dimethylaminoethylmethacrylate), poly(2-vinylpyridine), poly(4-vinylpyridine), or the like, or a combination comprising at least one of the foregoing synthetically derived cationic polymers. Copolymers that include at least one of the foregoing synthetically derived cationic polymers may also be used. Branched polyethylenimine is preferred.

Suitable anionic materials may be anionic polymers or anionic clays. Examples of anionic polymers include polyacrylic acid, polymethacrylic acid, polymaleic acid, poly(acrylamide/acrylic acid), poly(styrenesulfonic acid), poly(vinyl phosphoric acid), poly(vinylsulfonic acid), salts of polyacrylic acid, polymethacrylic acid, polymaleic acid, poly(acrylamide/acrylic acid), poly(styrenesulfonic acid), poly(vinyl phosphoric acid), poly(vinylsulfonic acid), or a combination comprising at least one of the foregoing anionic polymers. The anionic layer may also be a composite layer that contains inorganic materials in addition to the anionic polymer.

Inorganic materials may be used in the barrier coating. The anionic layer may comprise negatively charged platelets having a thickness of less than about 10 nanometers. Useful inorganic material includes platelet clays that can be exfoliated in aqueous or polar solvent environments. The clays may be naturally occurring or synthetic.

Platelet clays are layered crystalline aluminosilicates. Each layer is approximately 1 nanometer thick and is made up of an octahedral sheet of alumina fused to 2 tetrahedral sheets of silica. These layers are essentially polygonal two-dimensional structures, having a thickness of 1 nanometer and an average diameter of 30 to 2000 nanometers. Isomorphic substitutions in the sheets lead to a net negative charge, necessitating the presence of cationic counter ions (Na⁺, Li⁺, Ca²⁺, Mg²⁺, and the like) in the inter-sheet region. The sheets are stacked in a face-to-face configuration with inter-layer cations mediating the spacing. The high affinity for hydration of these ions allows for the solvation of the sheet in an aqueous environment. At sufficiently low concentrations of platelets, for example less than 1% by weight, the platelets are individually suspended or dispersed in solution. This is referred to as “exfoliation”.

Examples of suitable clays are anionic platelet materials such as laponite, montmorillonite, saponite, beidellite, vermiculite, nontronite, hectorite, fluorohectorite, or the like, or a combination comprising at least one of the foregoing clays. A preferred clay is montmorillonite or vermiculite.

The clay may be used in the anionic layer in amounts of 5 to 97 weight percent, based on the total weight of the anionic layer. In a preferred embodiment, the clay may be used in the anionic layer in amounts of 15 to 90 weight percent, based on the total weight of the anionic layer.

The layer-by-layer barrier coating may be optionally crosslinked by adding multifunctional agents to the anionic and/or cationic layers in a separate coating step or as a part of one of the solutions. The multifunctional agents may be added to only some of the anionic layers and some of the cationic layers, or alternatively it may be added to all of the anionic layers and cationic layers. In some cases, thermal treatment can allow crosslinking of the cationic and anionic layers, e.g., polyacrylic acid reaction with poly vinyl amine to form amide bonds.

The cross linking step may be conducted at the end of the deposition of each of the cationic or anionic layers or after the deposition of all of the layers. Multifunctional agents could include polyaldehydes, polyarizidenes, polyglycidyl ethers, or the like, including mixtures thereof, capable of reacting with one or more of the polymers in the barrier coating. Thermal treatment is also an option to cause crosslinking of the cationic and anionic layers.

The barrier coating comprises repeating alternating layers of cationic material and anionic material. The repeating alternating layers may be mathematically represented by the formula (1) or (2) depending upon whether the substrate contacts a cationic layer or an anionic layer of the barrier coating.

(cationic material/anionic material)ₙ (1) or

(anionic material/cationic material)ₙ (2)

where the presence of the cationic material or the anionic material in the numerator of formulas (1) or (2) indicates that this layer contacts the substrate either directly of via the first interfacial layer. For example, if the cationic material is a cationic polymer, then the numerator will state “cationic polymer”. Similarly, if the anionic material is an anionic clay, then the denominator will state “anionic clay”, and so on. The anionic material or the cationic material in the denominator contacts the cationic material or the anionic material respectively that contacts the substrate. The number “n” in the formulas (1) and (2) refers to the number of the cationic-anionic pair. Thus when n=1, the barrier layer comprises 1 pair of a cationic-anionic layer, which may also be referred to as a bilayer structure. When n=2, the barrier layer comprises 2 pairs of a cationic-anionic layers. The number “n” may vary for bilayers from 5 to 100, preferably 6 to 50, and more preferably 10 to 20 bilayers.

Examples of repeating patterns of two materials on an anionic substrate may include (cationic polymer/anionic clay)ₙ, or (cationic polymer/anionic polymer)ₙ. Similarly, oppositely charged bilayers could be applied to a cationic substrate. A preferred bilayer structure is polyethylenimine/vermiculite that is coated on an anionic substrate.

Examples of repeating patterns of more than two materials on an anionic substrate may include (cationic polymer/anionic polymer/cationic polymer/anionic clay)ₙ, referred to as quadlayer structures. As noted above, “n” for quadlayers may vary from 2 to 20, preferably 3 to 10, and more preferably 4 to 5 quadlayers. Similarly, oppositely charged quadlayers could be applied to a cationic substrate. Further, expansion to hexalayers and octalayers is also possible. Preferred quadlayer structures comprise a cationic polymer/anionic polymer/cationic polymer/montmorillonite. Most preferred quadlayer structures comprise a cationic polymer/anionic polymer/cationic polymer/vermiculite.

In one embodiment, in one method of manufacturing the barrier film, the substrate may be extruded or molded. A first interfacial layer comprising a reactive group may be disposed on the substrate if desired. The barrier coating may then be disposed on the substrate using a layer-by-layer process.

In one embodiment, a substrate with a reactive surface can be manufactured by coextruding a reactive polymer on a surface of a non-reactive polymer (i.e., a neutral polymer), laminating a reactive polymer on the surface of the non-reactive polymer or coating a reactive polymer on the surface of a non-reactive polymer. The reactive polymer surface could be derived from grafting a reactive monomer on to the surface of the non-reactive polymer. Any of these means result in a “substrate” that is reactive (covalent or ionic bonded) towards the first LBL coating layer.

Prior to the first coating step additional optional preparatory steps may be taken to prepare the substrate for coating, these can include washing the substrate and further activating the substrate using known techniques such as corona treatment, ozonolysis, flame ionization, and the like. The barrier coating may be disposed on either one or both sides of the substrate. In an exemplary embodiment, the barrier coating is disposed on only one side of the substrate.

The specific alternating pattern in a barrier coating can vary and include specific repeating patterns. The layer-by-layer coating process may employ a number of different types of processes including spray coating, dip coating or gravure coating. The process generally comprises multiple steps:

Step 1a: coat the substrate with a solution of the first cationic or anionic solution.

Step 1b (optional): rinse the coated substrate to remove excess material.

Step 1c (optional): air-dry the coated substrate.

Step 2a: coat the coated substrate with a solution of material which is oppositely charged to the previous layer.

Step 2b (optional): rinse the coated substrate to remove excess material.

Step 2c (optional): air-dry the coated substrate.

Step 3a, b, c: repeat steps a, b, c as needed to build the barrier coating.

Step 4: Dry the final structure to remove residual water in the barrier coating.

It is to be noted that while the foregoing steps are listed sequentially as steps 1, 2, 3 or 4, the steps can be performed in any desired order. For example, step 2c can be performed ahead of step 2b if desired.

In one embodiment, as listed above, the coating process can begin with either a cationic or anionic first layer combined with the appropriate reactive substrate (e.g., a substrate into which a first interfacial layer is dissolved or upon which it is disposed). Individual coating layers may be of a single anionic or cationic material or mixtures of similarly charged materials. Layer structures can vary widely with as few as two components to many different cationic and anionic materials.

Coating solutions can be either aqueous, organic or mixed solvent solutions or in the case of clays, suspensions. Coating solutions can vary in concentration, ionic strength, pH and the like. Coating variables such as exposure time, rinsing and drying time can be varied. Final drying conditions can be varied in temperature and length of time as needed. Platelet clay particles are generally completely or largely exfoliated prior to coating. A variety of known techniques can be utilized to maximize exfoliation of the clay.

A preferred method of applying the layer-by-layer coating is by dip coating the substrate. The substrate is cleaned and corona treated following which it is dipped in the first ionic solution. It is then subjected to rinsing and air drying, which may be repeated several times as needed. A drying step is then conducted to remove residual water.

Following this the substrate with the ionic coating disposed thereon is dipped in a second ionic solution having an opposing charge when compared with the first ionic solution. The substrate is then subjected to rinsing and air drying, which may be repeated several times as needed. A drying step is then conducted to remove residual water. The dipping is the respective ionic solutions may be conducted for as many times as necessary followed by repeated rinsing and air-drying steps.

The total barrier film (including the substrate) has a thickness of 10 to 3000 micrometers. In an exemplary embodiment, the total barrier film (including the substrate) has a thickness of 25 to 700 micrometers, preferably 50 to 200 micrometers. The barrier coating (which excludes the substrate) comprising alternating layers of cationic material and anionic material is 5 to 2000 nanometers, preferably 50 to 200 nanometers.

The layer-by-layer coated film (or sheet) thus prepared can be further laminated or bonded with other films to yield a final film structure. The layer-by-layer coated film or laminate can be subjected to additional forming (e.g., molding, vacuum forming, and the like), stretched or otherwise further fabricated to yield a final article. The layer-by-layer coated film or laminate can be fabricated into pouches, sachets, trays and the like. The fabricated article can be used for barrier packaging for foods, pharmaceuticals, cosmetics, and the like. The layer-by-layer coated film may be laminated or bonded with other films such as adhesive films, reinforcing films, or the like, as needed to meet other characteristics desired of the final article. Such other films may be monolayer or multilayer films.

The composition and manufacturing of the barrier film described herein is detailed in the following non-limiting example.

### EXAMPLE

### Comparative Example A

The substrate for this comparative example was prepared as follows. A substrate film sample that is approximately 200 micrometers thick and having a structure of 20 weight percent (wt %) AMPLIFY EA 100/60 wt % ELITE 5960/20% AMPLIFY EA 100 (AMPLIFY EA 100 is an ethylene-ethyl acrylate copolymer, ELITE 5960 is high density polyethylene, both manufactured by the Dow Chemical Company) was produced by Dow Chemical via cast coextrusion. Prior to coating, the substrate was corona-treated with a BD-20C Corona Treater (Electro-Technic Products Inc., Chicago, Ill.). It is to be noted that the substrate of this comparative example is non-reactive and does not react with the barrier coating disposed on it.

The cationic and anionic coatings used to form the barrier coatings are described below.

Coating Materials: Branched polyethylenimine (PEI) (Sigma-Aldrich, St. Louis, Mo.) (Mw˜25,000 g/mole) was dissolved into deionized water to create a 0.1 wt % cationic solution and the pH was adjusted from its natural value 10.5 to 10.0 by adding 1.0 M HCl. Poly (acrylic acid) (PAA) (Aldrich, St. Louis, Mo.) (Mw˜100,000 g/mole) was dissolved into deionized water to create a 0.2 wt % anionic solution and the pH was altered from 3.2 to 4.0 by adding 1.0M NaOH. Microlite 963++ vermiculite suspension (VMT) (Specialty Vermiculite Corporation, Enoree, S.C.) was diluted to 1% with water.

The coating process is detailed as follows. The substrate film (non-ionic, unreactive) is first dipped in the PEI solution (cation) for 5 minutes to allow the positively charged PEI to adsorb onto the surface, rinsed with deionized water for 30 seconds to remove excess PEI solution and dried with a stream of filtered air. The film is then dipped in the PAA solution (anion 1) for 1 minute to absorb the PAA onto the surface, rinsed with deionized water for 30 seconds and dried with a stream of filtered air. The film is then dipped in the PEI solution (cation) for 1 minute to adsorb the PEI onto the surface, rinsed with deionized water for 30 seconds and dried with a stream of filtered air. The film is then dipped in the VMT solution (anion 2) for 1 minute to adsorb the VMT onto the surface, rinsed with deionized water for 30 seconds and dried with a stream of filtered air. This creates a four layer coating with the structure of PEI/PAA/PEI/VMT. This four layer structure is referred to a one quadlayer. Coating then continues in this manner with 1 minute dip times until a total of 5 quadlayers have been applied to the surface. The coated film is then dried at 70° C. for 15 minutes. The resultant film is a LBL coated film where the coating is applied to both sides of the film.

The barrier testing of the comparative film A is detailed as follows. Two replicate samples of film were produced in this manner and tested for oxygen transmission rate (OTR). Two replicate samples of uncoated substrate were also tested for OTR. OTR testing was performed in accordance with ASTM D-3985, using a MOCON OX-TRAN 2/21 instrument at 23° C. and 50% and 80% relative humidity (RH). The results are shown in Tables 1 and 2 below.

### Example 1

This example details the composition and the manufacturing of the barrier film disclosed herein.

A substrate film sample that is 8 mil thick and having a structure of 20% PRIMACOR 1410/60% ELITE 5960/20% PRIMACOR 1410 (PRIMACOR 1410 is an ethylene-acrylic acid copolymer, ELITE 5960 is high density polyethylene, both manufactured by the Dow Chemical Company) was produced by Dow Chemical via cast coextrusion. Prior to coating the substrate was corona-treated with a BD-20C Corona Treater (Electro-Technic Products Inc., Chicago, Ill.).

The coating materials are the same as in Comparative Example A and the coating process is the same as that in Comparative Example A, except that the anionic, reactive substrate film was used in place of the non-ionic, unreactive substrate of Comparative Example A.

The barrier testing is the same as that conducted for the Comparative Example A. the results are shown in Table 1 ad 2 below.

Table 1 shows the oxygen transmission rate at 50 percent relative humidity.

TABLE 1

| Sample | Substrate Only | Coated Film | Improvement |
|---|---|---|---|
| Comparative Example | 500* | 480 | 4% |
| A | | | |
| Example 1 | 410 | 4.2 | 99% |

*units for all results are cc/m2-atm-day

Table 2 below shows the oxygen transmission rate at 80 percent relative humidity.

TABLE 2

| Sample | Substrate Only | Coated Film | Improvement |
|---|---|---|---|
| Comparative Example | 500* | 460 | 8% |
| A | | | |
| Example 1 | 410 | 15 | 96% |

*units for all results are cc/m2-atm-day

Results shown in Tables 1 and 2 demonstrate that the non-ionic, unreactive substrate did not show any significant barrier improvement upon coating whereas the anionic, reactive substrate of Example 1 showed almost two orders of magnitude barrier improvement. From the Tables 1 and 2 it may be seen that there is an improvement of 80 to 99%, preferably 85 to 96%, and more preferably 90 to 95% over a comparative film that comprises a substrate that is not reacted to the opposedly charged ionic layers (that form the barrier coating comprising alternating layers of cationic material and anionic material).

What is claimed is:

1. A barrier film comprising:
a substrate comprising a first surface and a second surface; where the first surface and the second surface are opposedly disposed to each other; and
a barrier coating comprising alternating layers of cationic material and anionic material; where the barrier coating is reactively bonded with at least the first surface of the substrate.

2. The barrier film of claim 1, where the reactive bonding comprises ionic bonding or covalent bonding.

3. The barrier film of claim 1, where the cationic material comprises a cationic polymer that is naturally derived; where the naturally derived cationic polymers is chitosan.

4. The barrier film of claim 1, where the cationic material comprises a cationic polymer that is synthetically derived; where the synthetically derived cationic polymers are branched polyethylenimine, linear polyethylenimine, polydiallyldimethyl ammonium chloride, polyallylamine hydrochloride, poly-L-lysine, poly(amidoamines), poly(amino-co-esters), poly(2-N,N-dimethylaminoethylmethacrylate), poly(ethylene glycol-co-2-N,N-dimethylaminoethylmethacrylate), or a combination comprising at least one of the foregoing synthetically derived cationic polymers.

5. The barrier film of claim 1, where the anionic material comprises an anionic polymer; where the anionic polymer is polyacrylic acid, polymethacrylic acid, polyacrylamide, poly(styrenesulfonic acid), poly(vinyl phosphoric acid), poly(vinylsulfonic acid), salts of polyacrylic acid, polymethacrylic acid, polyacrylamide, poly(styrenesulfonic acid), poly(vinyl phosphoric acid), poly(vinylsulfonic acid), or a combination comprising at least one of the foregoing synthetically derived cationic polymers.

6. The barrier film of claim 1, where the anionic material comprises a clay; where the clay is laponite, montmorillonite, saponite, beidellite, vermiculite, nontronite, hectorite, fluorohectorite, or a combination comprising at least one of the foregoing clays.

7. The barrier film of claim 1, where at least one of the cationic material and anionic material are crosslinked.

8. The barrier film of claim 1, where the barrier coating comprises a bilayer structure; where the bilayer structure comprises a cationic material layer of polyethylenimine and an anionic material layer of vermiculite.

9. The barrier film of claim 1, where the barrier coating comprises a quadlayer structure; where the quadlayer structure comprises a first cationic material layer that comprises polyethylenimine in contact with the substrate; a first anionic material layer that comprises polyacrylic acid in contact with the first cationic material layer; a second cationic material layer that comprises polyethylenimine in contact with the first anionic material layer; and a second anionic material layer that comprises vermiculite or montmorillonite; where the second anionic material layer contacts the second cationic material layer.

10. The barrier film of claim 1, where the substrate comprises an ethylene-acrylic acid copolymer, an ethylene-methacrylic acid copolymer, inorganic salts of the ethylene-acrylic acid copolymer, inorganic salts of the ethylene-methacrylic acid copolymer, maleic anhydride grafted polyethylene, polystyrene sulfonic acid, styrene acrylic acid copolymer, or a combination comprising at least one of the foregoing substrates.

11. An article comprising the composition of claim 1.

12. A method comprising:
disposing upon a substrate a barrier coating comprising alternating layers of cationic material and anionic material; where the barrier coating is reactively bonded with at least one surface of the substrate.

13. The method of claim 12, further comprising extruding the substrate.

14. The method of claim 13, where the disposing comprises dip coating, spray coating, brush painting, gravure coating, or combinations thereof.
